(19) United States
(12) Patent Application Publication
(10) Pub. No.: US 2015/0214741 A1
(43) Pub. Date: Jul. 30, 2015

(54) SYSTEM CONTROL DEVICE AND SYSTEM CONTROL METHOD

(71) Applicant: HITACHI, LTD., Chiyoda-ku, Tokyo (JP)

(72) Inventors: Eisuke Kuroda, Chiyoda-ku (JP); Yasuo Sato, Chiyoda-ku (JP); Taichiro Kawahara, Chiyoda-ku (JP); Koichi Hara, Chiyoda-ku (JP)

(21) Appl. No.: 14/422,597

(22) PCT Filed: Jun. 24, 2013
(86) PCT No.: PCT/JP2013/067168

§ 371 Date: Feb. 19, 2015

(30) Foreign Application Priority Data
Sep. 21, 2012 (JP) 2012-207822

(51) Int. Cl. H02J 4/00; G05B 15/02

(52) U.S. Cl. CPC H02J 4/00; G05B 15/02

(57) ABSTRACT

A device in a power system is controlled so that the power system becomes close to a desired system state. Provided is a system control device including a storage unit which stores target information representing a target voltage phase of a specific site in a power system and measurement information representing a voltage phase of a measurement result of the specific site, and a control unit which controls a target device associated with the power system based on a difference between the measurement information and the target information.

### TECHNICAL FIELD

The present invention relates to a technique for controlling a power amount of a power system.

### BACKGROUND ART

In the future, a large amount of renewable energy is expected to be introduced to a power system. Great output fluctuation occurs in the renewable energy according to weather or the like. Therefore, if a large amount of the renewable energy is introduced to the power system, great voltage fluctuation or great power flow fluctuation occurs, so that there is a problem in that a stability of the power system is deteriorated.

On the other hand, phasor measurement units (PMU) as a device for measuring absolute time added power information (phase information of voltage) using a global positioning system (GPS) are known. Recent years, the PMUs have been increasingly used for system monitoring or system control.

A method of utilizing absolute time added power information measured by the PMU for stabilization control is known. For example, PTL 1 discloses a method of checking stability margin of a dominant power disturbance in the power system and performing the stabilization by configuring a power system disturbance model including a model of an auxiliary signal generated by a power system stabilizer (PSS) of a generator excitation system by using measurement data of voltage phase measurement devices having a GPS time synchronization function arranged in a wide area.

In addition, a method of measuring absolute time added power information by using the PMU or the like is known. For example, PTL 2 discloses a power system disturbance detection device where terminal devices at different sites of a power system detect voltage phases and transmit the voltage phases to each other, so that the occurrence of system disturbance is detected based on voltage phase information after the occurrence of accident, and each terminal device is configured to include a timer unit installed to accurately measure an absolute time, a unit for measuring the voltage phase every predetermined time, a unit for transmitting measured voltage phase information, and a unit for detecting system disturbance based on the transmitted voltage phase information. In addition, PTL 3 discloses a method where, in the case of measuring a phase difference between AC electricity quantities of two points separated from each other, measurement devices are installed at the two points, a time difference between a rising edge of a reference waveform and a rising zero cross of the AC electric quantity is measured at the same time by using a time acquired from a GPS signal and reference waveforms synchronized in time based on the GPS signal, the time difference and the time are transmitted to each other in a measurement period, and a phase difference between the AC electric quantities of the two points is calculated from a difference between the time differences.

In addition, a method of estimating a power system state based on a measured value is known (for example, NIL 1).

### CITATION LIST

### Patent Literature

PTL 1: WO 2006/090538 A
PTL 2: JP 9-93792 A
PTL 3: JP 2008-249472 A

### Non-Patent Literature

NPL 1: Lars Holten, Anders Gjelsvlk, Sverre Adam, F. F. Wu, and Wen-Hs IungE. Liu, Comparison of Different Methods for State Estimation, IEEE Transaction on Power Systems, Vol. 3 (1988), p. 1798-1806

### SUMMARY OF INVENTION

### Technical Problem

In order to allow a power system to be in a desired system state by central control, information on the entire power system needs to be checked, so that there is a problem in that the cost of communication facilities or the like is increased. On the other hand, in the case of local control where local information as partial information of the power system is checked and a portion of the power system is controlled, it is impossible to allow the entire system to be in a desired system state.

There is also disclosed a method of providing a control command to a system control device which is locally installed in order to implement a desired system state by using a voltage measured by a voltage measurement device. However, since the measurement error of the voltage is large, there is a problem in that the cost is increased in order to improve the accuracy.

### Solution to Problem

According to an aspect of the invention, there is provided a system control device including a storage unit which stores target information representing a target voltage phase of a specific site in a power system and measurement information representing a voltage phase of a measurement result of the specific site, and a control unit which controls a target device associated with the power system based on a difference between the measurement information and the target information.

### Advantageous Effects of Invention

According to the invention, it is possible to control devices in a power system so that the power system becomes close to a desired system state.

### BRIEF DESCRIPTION OF DRAWINGS

FIG. 1 illustrates a configuration of a system control device 10 according to an embodiment of the invention.

FIG. 2 illustrates a hardware configuration of the system control device 10.

FIG. 3 illustrates stored contents of program database 24a.

FIG. 4 illustrates specific time added voltage phase target data D1.

FIG. 5 illustrates specific time added voltage phase measurement data D2.

FIG. 6 illustrates control device data D3.

FIG. 7 illustrates a system control process of a system control device 10.

FIG. 8 illustrates a configuration of a calculation server 210.

FIG. 9 illustrates a hardware configuration of the calculation server 210.

FIG. 10 illustrates stored contents of program database 24b.

FIG. 11 illustrates absolute time added power information.

FIG. 12 illustrates branch information in network configuration information.

FIG. 13 illustrates transformer information in the network configuration information.

FIG. 14 illustrates node information in the network configuration information.

FIG. 15 illustrates generator data D6.

FIG. 16 illustrates voltage constraint data.

FIG. 17 illustrates power flow constraint data.

FIG. 18 illustrates a calculation process of the calculation server 210.

FIG. 19 illustrates a change in voltage stability margin by control for changing an operating point.

FIG. 20 illustrates a change in voltage stability margin by control for changing a PV curve.

FIG. 21 illustrates a control result display screen.

FIG. 22 illustrates a system state display screen.

### DESCRIPTION OF EMBODIMENTS

Hereinafter, embodiments of the invention will be described with reference to the drawings.

### First Embodiment

In the embodiment, a system control device which calculates a difference between specific time added voltage phase target database calculated by a calculation server and specific time added voltage phase measurement data measured by a measurement device and controls a control target device in a power system based on the calculated difference is described. In addition, in the embodiment, an example where the system control device cannot have a configuration of a partial power system, line parameters, or the like is described.

### --Configuration of System Control Device--

Hereinafter, a configuration of the system control device will be described.

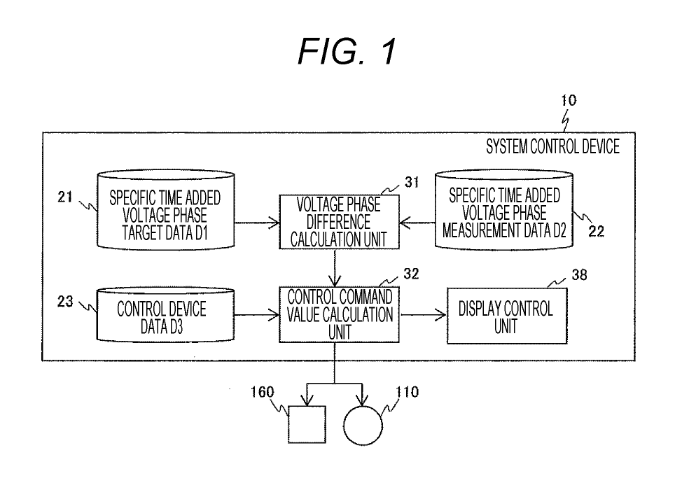

FIG. 1 illustrates a configuration of the system control device 10 according to the embodiment of the invention. The system control device 10 is configured to include a specific time added voltage phase target data D1, a specific time added voltage phase measurement data D2, a control device data D3, a voltage phase difference calculation unit 31, a control command value calculation unit 32, and a display control unit 38. The system control device 10 is connected to a control target device (target device) which is a device as a control target. The control target device is a distributed generator such as a power supply 110 and a battery 160. The power supply 110 is, for example, a generator using renewable energy. The battery 160 performs charging and discharging.

Herein, terms in the later-described expressions are described. Target information corresponds to, for example, specific time added voltage phase target data D1. Measurement information corresponds to, for example, specific time added voltage phase measurement data D2.

The system control device 10 is input with the specific time added voltage phase target data D1, the specific time added voltage phase measurement data D2, and control device data D3 as input data. The specific time added voltage phase target data D1 represent a target voltage phase. The specific time added voltage phase measurement data D2 represent a voltage phase of a measurement result.

The voltage phase difference calculation unit 31 calculates voltage phase difference between the target voltage phase and the voltage phase of the measurement result by using the specific time added voltage phase target data D1 and the specific time added voltage phase measurement data D2. In addition, the control command value calculation unit 32 calculates a control command value for the control target device by using the voltage phase difference which is a calculation result of the voltage phase difference calculation unit 31 and the control device data D3 and produces a control command for the control target device. The control command includes the control command value, a time, and ID. The control command value calculation unit 32 periodically transmits the control command to the control target device. Receiving the control command, the power supply 110 and the battery 160 provide outputs to the power system according to the control command. The display control unit 38 generates a control result display screen illustrating a control result according to the control command.

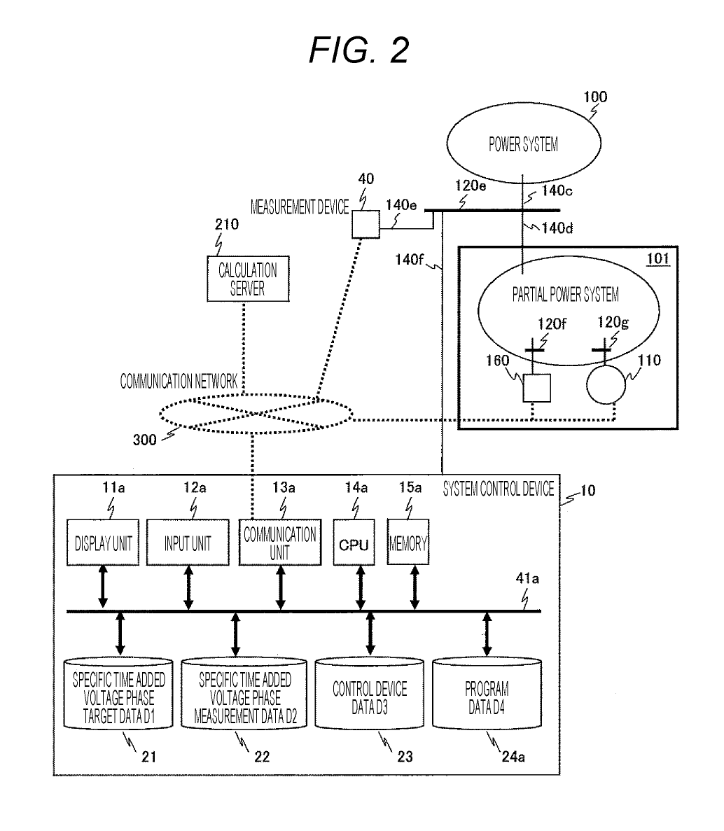

FIG. 2 illustrates a hardware configuration of the system control device 10. The system control device 10 is connected to a partial power system 101, a calculation server 210, and a measurement device 40 via a communication network 300. The partial power system 101 has interconnection to the power system 100 through a node 120e. In addition, the system control device 10 and the measurement device 40 are connected to the node 120e.

The power system 100 includes any one of components of a generator, a transformer, a branch, and a load. These components are connected to a node (bus). The partial power system 101 includes any one of components of the power supply 110, the battery 160, a branch 140d, and a load. These components are connected to nodes 120f and 120g. The power system 100 is connected to the node 120e through a branch 140c.

The partial power system 101 is connected to the node 120e through the branch 140d so as to have interconnection to the power system 100. The power supply 110 and the battery 160 of the partial power system 101 are connected to a communication unit 13a of the system control device 10 through a communication network 300 to transmit/receive the control command to/from the system control device 10. The power system 100 is configured to include a plurality of the partial power systems including the partial power system 101. The partial power system 101 may be configured to include a plurality of power distribution systems. For example, the system control device 10 is installed in a transformer substation for power distribution which supplies power to the partial power system 101.

The calculation server 210 is connected to the communication unit 13a of the system control device 10 via the communication network 300 to calculate the specific time added voltage phase target data D1 and transmit the specific time added voltage phase target data to the system control device 10.

The measurement device 40 is configured to include a measurement unit and a communication unit. The measurement unit of the measurement device 40 is connected to a specific site in the power system 100. In the embodiment, the measurement unit of the measurement device 40 is connected to the node 120e through a branch 140e. The power system 100 and the partial power system 101 are connected to the node 120e. The communication unit of the measurement device 40 is connected to the communication unit 13a of the system control device 10 via the communication network 300 to measure absolute time added power information and transmit the absolute time added power information to the system control device 10. The absolute time added power information is, for example, the specific time added voltage phase measurement data D2.

Herein, the measurement device 40 is, for example, a PMU. The PMU measures the absolute time added power information by using GPS and transmits the absolute time added power information as the specific time added voltage phase measurement data D2 to the system control device 10. In addition, the measurement device 40 may be any other measurement devices capable of measuring the absolute time added power information. In addition, the measurement device 40 may measure an absolute time added current. The measurement device 40 may be included in the system control device 10. In addition, a plurality of the measurement devices 40 may be installed in the power system 100. In addition, the measurement device 40 may be installed in the transformer substation for power distribution. In addition, the power information represents any one of an active power P, a reactive power Q, a voltage V, and a phase δ.

The specific time added voltage phase target data D1 and the specific time added voltage phase measurement data D2 may be phasor information including an amplitude and a phase of a voltage or may be complex information including a real part and an imaginary part of the voltage.

The control target device has interconnection to the partial power system 101. The control target device may be a load or other electric devices besides a distributed generator such as the power supply 110 and the battery 160. The load includes electric devices (air conditioners, refrigerators, washing machines) or the like which are only to consume power but not assumed to be controlled in consumer's home and controllable loads (heat pumps or the like) which are assumed to be controlled. The loads which are not assumed to be controlled may also be controlled through a management system such as a home server communicating with the loads or a home energy management system (HEMS). In addition, the partial power system 101 may include a management system which collectively manages the control target devices such as the power supply 110 and the battery 160. The management system is, for example, a community energy management system (CEMS) and may transmit the control command to the control target device based on the control command from the system control device 10.

The battery 160 is, for example, a rechargeable secondary battery, a storage battery of an EV (Electric Vehicle), or a flywheel. The power supply 110 is, for example, a distributed generator requiring a power conversion device or a distributed generator requiring no power conversion device. The distributed generator requiring the power conversion device is, for example, a power generator using natural energy such as solar generator or wind power generator. The power conversion device is a device which converts phases or magnitudes of the voltage V and the current I generated by the power supply 110 by using an inverter and a converter and transmits the converted voltage V and current I to a distribution board. The distributed generator requiring no power conversion device is, for example, a small-sized generator such as a gas turbine or a diesel generator. In the case of the gas turbine or the small-sized generator, the power conversion device is connected to the distribution board without any intervention.

The system control device 10 is connected to the node 120e through a branch 140f. The system control device 10 is, for example, a computer such as a calculator server. The system control device 10 is configured to include a display unit 11a, an input unit 12a such as a keyboard or a mouse, a communication unit 13a, a CPU (Central Processing Unit) 14a, a memory 15a, and a database. The database includes a specific time added voltage phase target database 21, a specific time added voltage phase measurement database 22, a control device database 23, and a program database 24a. Each component of the system control device 10 is connected to a bus line 41a.

Herein, terms in the later-described expressions are described. A storage unit corresponds to, for example, the memory 15a. A control unit corresponds to, for example, the CPU 14a. A calculator corresponds to, for example, the calculation server 210.

The display unit 11a is, for example, a display device. In addition, the display unit 11a may include a printer device, a sound output device, or the like instead of the display device or together with the display device. The input unit 12a includes at least one of, for example, a pointing device such as a keyboard switch or a mouse, a touch panel, and a voice instruction device. The communication unit 13a is a circuit for accessing the communication network 300 and is operated according to a predetermined communication protocol.

The CPU 14a may be one or plural semiconductor chips or may be a computer device such as a calculator server. The CPU 14a executes a computer program read from the program database 24a to the memory 15a to perform calculating the voltage phase difference, calculating the control command value, instructing to-be-displayed image data, and searching data in various databases. The computer program may be stored in a computer-readable storage medium and may be installed from the computer-readable storage medium to the system control device 10.

The memory 15a is, for example, a RAM (Random Access Memory) and stores the computer program read from the program database 24a or temporarily stores image data, control data, control result data, calculation temporary data, calculation result data, and the like.

The control result display screen which is generated by the display control unit 38 to be stored in the memory 15a is displayed by the display unit 11a. An example of the control result display screen will be described later.

Hereinafter, the databases in the system control device 10 will be described.

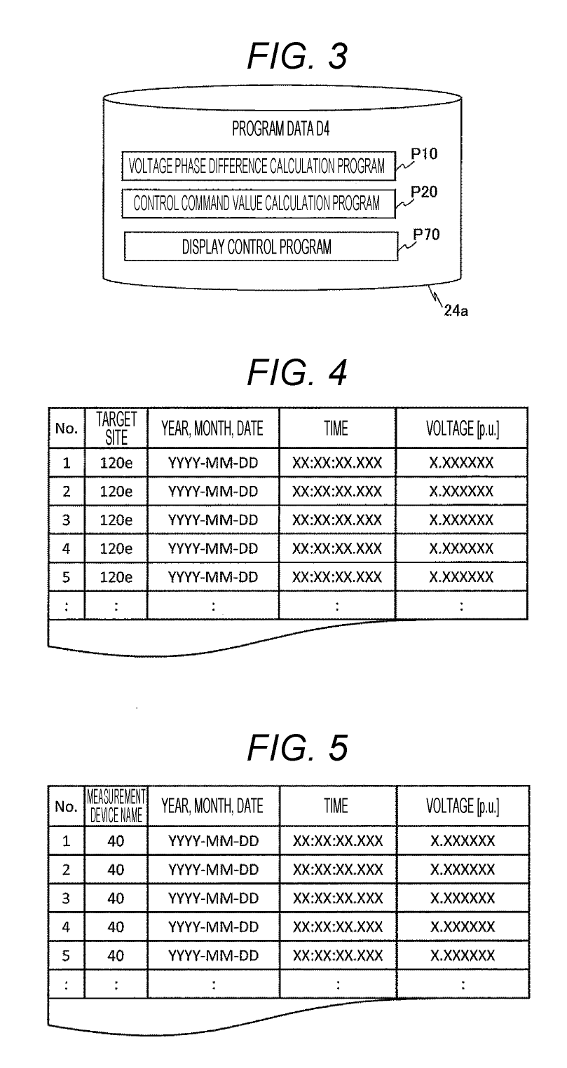

FIG. 3 illustrates stored contents of the program database 24a. Program data D4 are stored in the program database 24a. The program data D4 include, for example, a voltage phase difference calculation program P10, a control command value calculation program P20, and a display control program P70. The voltage phase difference calculation program P10 allows the CPU 14a to function as the voltage phase difference calculation unit 31. The control command value calculation program P20 allows the CPU 14a function as the control command value calculation unit 32. The display control program P70 allows the CPU 14a to function as the display control unit 38.

The specific time added voltage phase target data D1 of the node 120e are stored in the specific time added voltage phase target database 21. The calculation server 210 calculates the specific time added voltage phase target data D1 and transmits the specific time added voltage phase target database to the system control device 10. The voltage phase difference calculation unit 31 receives the specific time added voltage phase target data D1 from the calculation server 210 and stores the specific time added voltage phase target data in the specific time added voltage phase target database 21. FIG. 4 illustrates the specific time added voltage phase target data D1. The specific time added voltage phase target data D1 represent a voltage phase target value for every time cross-section. In this example, the target site is the node 120e measured by the measurement device 40. The specific time added voltage phase target data D1 include a target value number, a target site, a date (year, month, date) of the time cross-section setting the target value, and a time of the time cross-section, and a voltage of the target value. A method of calculating the specific time added voltage phase target data D1 performed by the calculation server 210 will be described later.

The specific time added voltage phase measurement data D2 of the measured node 120e are stored in the specific time added voltage phase measurement database 22. The measurement device 40 measures the specific time added voltage phase measurement data D2 and transmits the specific time added voltage phase measurement data to the system control device 10. The voltage phase difference calculation unit 31 receives the specific time added voltage phase measurement data D2 from the measurement device 40 and stores the specific time added voltage phase measurement data in the specific time added voltage phase measurement database 22. FIG. 5 illustrates the specific time added voltage phase measurement data D2. The specific time added voltage phase measurement data D2 represent a voltage phase measured value for every time cross-section. In this example, the measurement device is the measurement device 40 which measures the target site. The specific time added voltage phase measurement data D2 include a measured value number, a measurement device, a date (year, month, date) of the measured value of the time cross-section, and a time of the time cross-section, and a voltage of the measured value.

The time cross-section of each of the specific time added voltage phase target data D1 and the specific time added voltage phase measurement data D2 may represent a specific time in some time zone or may represent plural specific time in some time zone.

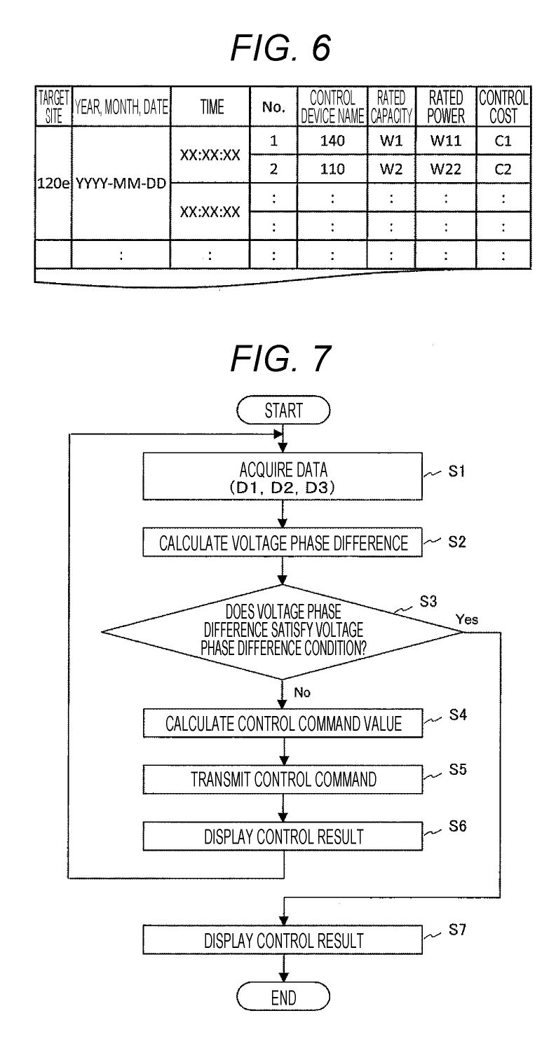

The control device data D3 are stored in the control device database 23. The control device data D3 are data of each control target device at every time cross-section with respect to the control target device such as the power supply 110 or the battery 160 existing in the partial power system 101. The control target device is a device capable of controlling a reactive power and is, for example, a distributed generator (DG), a static var compensator (SVC), a step voltage regulator (SVR), a shunt capacitor (SC), and a shunt reactor (ShR). FIG. 6 illustrates the control device data D3. The control device data D3 include a target site, a date of the time cross-section, a time of the time cross-section, a data number, a control target device name, a rated capacity of the control target device, a rated power of the control target device, and a control cost for the control target device. The control device data D3 may include information representing whether or not the control target device is controllable.

### --System Control Process of System Control Device 10--

Hereinafter, system control process of the system control device 10 will be described. In the system control process, the system control device 10 calculates the voltage phase difference by using the specific time added voltage phase target data D1 received from the calculation server 210 and the specific time added voltage phase measurement data D2 received from the measurement device 40 and stores the voltage phase difference. In the case where the voltage phase difference satisfies a predetermined voltage phase difference condition, the system control device 10 displays the system state on a screen and ends the system control process. On the other hand, in the case where the voltage phase difference does not satisfy the voltage phase difference condition, the system control device 10 calculates the control command value for the control target device so as to decrease the voltage phase difference by using the voltage phase difference and the control device data D3 and transmits the control command to the control target device. Until the voltage phase difference satisfies the voltage phase difference condition, the system control device 10 repeats the calculation of the control command value, the transmission of the control command, and the displaying of the control result on the screen. In the case were voltage phase difference satisfies the voltage phase difference condition, the system control device 10 displays the control result on the display unit 11a and ends the system control process.

FIG. 7 illustrates the system control process of the system control device 10.

In step S1, the voltage phase difference calculation unit 31 acquires data required for the calculation of the voltage phase difference and the calculation of the control command value. Herein, the voltage phase difference calculation unit 31 receives the specific time added voltage phase target data D1 from the calculation server 210 and stores the specific time added voltage phase target data in the specific time added voltage phase target database 21. In addition, the voltage phase difference calculation unit 31 receives the specific time added voltage phase measurement data D2 from the measurement device 40 and stores the specific time added voltage phase measurement data in the specific time added voltage phase measurement database 22. In addition, the voltage phase difference calculation unit 31 acquires the control device data D3 representing the rated capacity or the rated power for each time cross-section and the control cost or the like with respect to the power supply 110, the battery 160 or the like existing in the partial power system 101 and stores the control device data in the control device database 23.

Herein, the control device data D3 may be input to the system control device 10 by user's manipulation of the input unit 12a, or the system control device 10 may receive the control device data D3 from the control target device, the management system, or the like via the communication network 300. In addition, in the case where the control device data D3 is input by the user, the CPU 14a is allowed to generate the required image data and display the image data on the display unit 11a. In this case, the CPU 14a may execute semi-manual input by using a complementary function so that a larger amount of data than the input amount can be set. In the case where the system control device 10 receives the control device data D3, the CPU 14a may indirectly receive the control device data D3 through the system management server of an aggregator, a power company, or a broker which contracts with each home consumer and the management system such as CEMS or HEMS and may set the control device data in the control device database 23.

Herein, the voltage phase difference calculation unit 31 may collectively receive the specific time added voltage phase target data D1 of plural time cross-sections included in a specific time zone from the calculation server 210. In addition, the voltage phase difference calculation unit 31 may collectively receive the specific time added voltage phase measurement data D2 of the plural time cross-sections included in the specific time zone from the measurement device 40. In addition, the voltage phase difference calculation unit 31 may collectively receive the control device data D3 of the plural time cross-sections included in the specific time zone from the control target device, the management system, or the like.

In step S2, the voltage phase difference calculation unit 31 calculates the voltage phase difference by using the voltage phase difference calculation program P10 and stores the voltage phase difference in the memory 15a. Herein, the voltage phase difference calculation unit 31 calculates the voltage phase difference which is a deviation from the voltage phase target value by subtracting the specific time added voltage phase target data D1 from the specific time added voltage phase measurement data D2 for each time cross-section (time).

In step S3, the voltage phase difference calculation unit 31 determines whether or not the calculated voltage phase difference satisfies the voltage phase difference condition. The voltage phase difference condition is, for example, that the voltage phase difference is in a predetermined range or that the absolute value of the voltage phase difference is less than a predetermined threshold value. The threshold value is set as a setting value representing an upper limit of the voltage phase difference during the installation of the control target device. In the case where it is determined that the voltage phase difference satisfies voltage phase difference condition (S3: Yes), the voltage phase difference calculation unit 31 transfers the process to step S7. In the case where it is determined that the voltage phase difference does not satisfy the voltage phase difference condition (S3: No), the voltage phase difference calculation unit 31 transfers the process to step S4.

Herein, the process for the case were it is determined as a result of step S3 that the voltage phase difference does not satisfy the voltage phase difference condition (S3: No) will be described.

In step S4, the control command value calculation unit 32 calculates the control command value for the power supply 110 and the battery 160 by using the control device data D3. The embodiment discloses an example of a method of calculating the control command value in the case where the configuration of the partial power system 101, the line parameters, or the like is unknown. The control command value calculation unit 32 acquires influence and sensitivity of the increase or decrease of the output of each of the power supply 110 and the battery 160 with respect to the voltage phase difference in advance. After that, the control command value calculation unit 32 determines the control command value so that the control costs of the control target devices for each time cross-section are balanced in a predetermined range. In addition, in the case where the sensitivity is greatly low, the control command value calculation unit 32 determines that the control target device is not operated, so that the control target device is not considered. The control command value calculation unit 32 first calculates the control command value so that the output of the control target device having low control cost is increased or decreased preferentially. In the subsequent process, the control command value calculation unit 32 measures the influence on the voltage phase difference and feeds the influence back to calculate the next control command value. For example, the voltage phase difference is increased after the transmission of the control command which changes the control command value, the control command value calculation unit 32 inverts the direction of the change of the control command value and calculates the next control command value. Therefore, the control command value calculation unit 32 allows the voltage phase difference to gradually reach the target range. The control command value calculation unit 32 calculates the control command value and, after that, transfers the process to step S5.

In step S5, the control command value calculation unit 32 transmits the control command including the calculated control command value to the power supply 110 and the battery 160 in the partial power system 101.

The control target device may be connected to a terminal station such as an HEMS, a PCS (Power Conditioning System), a monitoring device, or a supply/demand controller, and a plurality of the terminal stations installed in some area may be connected to a repeater. In this case, the control command value calculation unit 32 transmits the control command to the repeater connected to the communication network 300, and the repeater transmits the control command to the terminal station. According to this communication method, in the case where there exist a large number of the control target devices in the partial power system 101, the communication amount or load of the system control device 10 is reduced, so that it is possible to avoid congestion.

In step S6, the display control unit 38 receives the control result from the measurement device 40. The control result represents, for example, how the measured value of the voltage phase is changed according to the transmitted control command. Next, the display control unit 38 generates the control result display screen illustrating the control result and displays the control result display screen on the display unit 11a. In addition, the display control unit 38 may receive the control effect representing the effect of the transmitted control command value from the calculation server 210 and may further generate the control result display screen illustrating the control effect and display the control result display screen on the display unit 11a. The control effect represents, for example, an increase amount of the voltage stability margin. The control result display screen may be numerical data or image data. The control result display screen will be described later. After that, the display control unit 38 transfers the process to step S1.

In the second step S4 of the loop of steps S1 to S6, the control command value calculation unit 32 may calculate the control command value by feeding the control effect back so that the voltage phase difference is allowed to gradually reach the target value. Until the voltage phase difference is in the target range in step S3, the loop is performed. In addition, the calculation server 210 may perform time-series learning for each predetermined time zone in advance to produce a time-zone model representing the control effect of the reactive power or the voltage of the control target device with respect to the control command value for the control target device. In this case, the control command value calculation unit 32 may receive the time-zone model and calculate the control command value by using the time-zone model. In addition, in the case where the loop is performed a predetermined number of times so that an endless loop does not occur, the voltage phase difference calculation unit 31 forcibly transfers the process to step S7.

Herein, the process of the case where it is determined as a result of step S3 that the voltage phase difference satisfies the voltage phase difference condition (S3: Yes) will be described.

In step S7, the control command value calculation unit 32 generates the above-described control result display screen, displays the control display screen on the display unit 11a, and ends the flow.

Heretofore, the flow of the system control process is described.

The system control device 10 controls the control target device in the partial power system 101 so as to allow the specific time added voltage phase measurement data D2 to become close to the specific time added voltage phase target data D1, so that the power system 100 is allowed to become close to the desired system state. In addition, the system control device 10 calculates the control command value so as to allow the difference between the specific time added voltage phase measurement data D2 and the specific time added voltage phase target data D1 to become close to zero, so that the power system 100 is allowed to become close to the desired system state.

### --Configuration of Calculation Server 210--

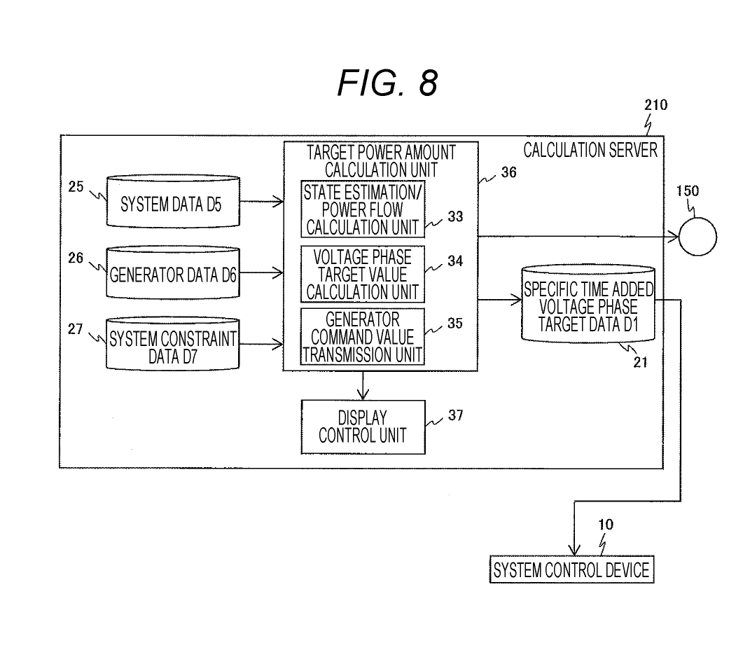

FIG. 8 illustrates a configuration of the calculation server 210. The calculation server 210 includes a system data D5, a generator data D6, a system constraint data D7, a target power amount calculation unit 36, a display control unit 37, and a specific time added voltage phase target data D1. The calculation server 210 is connected to generators 150a and 150b and the system control device 10 via the communication network 300. The target power amount calculation unit 36 is configured to include a state estimation/power flow calculation unit 33, a voltage phase target value calculation unit 34, and a generator command value transmission unit 35.

The system data D5, the generator data D6, and the system constraint data D7 are input as input data to the calculation server 210.

The state estimation/power flow calculation unit 33 estimates the system state by using the system data D5 to calculate the power flow of the system. The voltage phase target value calculation unit 34 calculates the voltage phase target value by using the state estimation result and the system constraint data D7 to generate the specific time added voltage phase target data D1 for the system control device 10. In the case where the control command for the generator is available from the calculation server 210, the voltage phase target value calculation unit 34 calculates the control command values for the generators 150a and 150b by using the state estimation result and the generator data D6. The voltage phase target value calculation unit 34 periodically transmits the specific time added voltage phase target data D1 to the system control device 10. The generator command value transmission unit 35 periodically transmits the control commands to the generators 150a and 150b. Each of the generators 150a and 150b receiving the control commands sets the power for the power system 100 according to each of the control commands. The display control unit 37 generates a system state display screen illustrating the estimated system state or the measured value measured by a sensor in the power system 100.

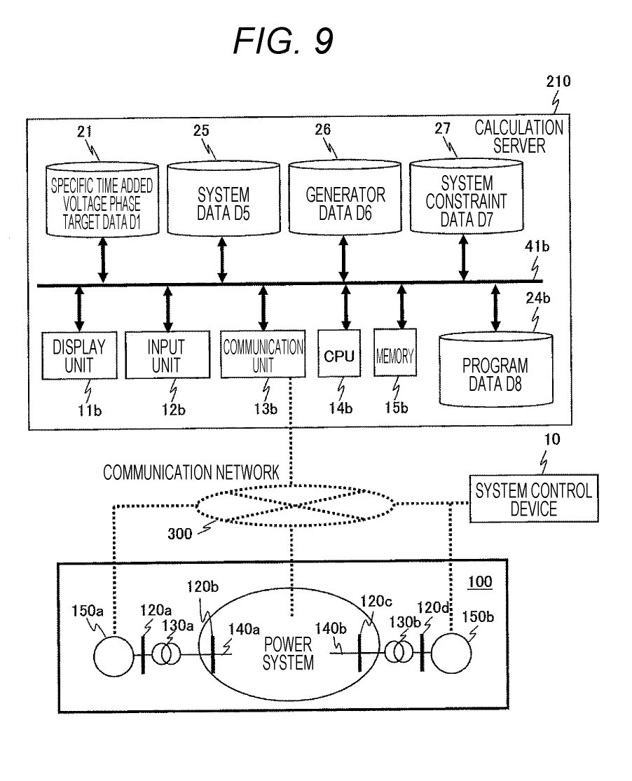

FIG. 9 illustrates a hardware configuration of the calculation server 210. The calculation server 210 is connected to the power system 100 and the system control device 10 via the communication network 300.

The power system 100 includes any one of generators, transformers, and branches. For example, the power system 100 include a branch 140a, anode 120b connected to the branch 140a, a transformer 130a connected to the node 120b, a node 120a connected to the transformer 130a, and a generator 150a connected to the node 120a. The power system 100 further includes a branch 140b, anode 120c connected to the branch 140b, a transformer 130b connected to the node 120c, a node 120d connected to the transformer 130b, and a generator 150b connected to the node 120d.

The measurement device installed in the power system 100 and the measurement devices installed in the generators 150a and 150b are connected to a communication unit 13b of the calculation server 210 via the communication network 300 to transmit the system data D5 and the generator data D6 to the calculation server 210.

The communication unit 13b of the calculation server 210 is connected to the communication unit 13a of the system control device 10 via the communication network 300 to transmit the specific time added voltage phase target data D1 to the system control device 10. The calculation server 210 is connected to the generators 150a and 150b in the power system 100 via the communication network 300 to transmit the control commands to the generators 150a and 150b.

The calculation server 210 is, for example, a computer such as a calculator server. The calculation server 210 is configured to include a display unit 11b, an input unit 12b such as a keyboard or a mouse, a communication unit 13b, a CPU 14b, a memory 15b, and a database. The database includes a specific time added voltage phase target database 21, a system database 25, a generator database 26, a system constraint database 27, and a program database 24b. Each components of the calculation server 210 is connected to a bus line 41b.

The display unit 11b is, for example, a display device. In addition, the display unit 11b may include a printer device, a sound output device, or the like instead of the display device or together with the display device. The input unit 12b includes at least one of, for example, a pointing device such as a keyboard switch or a mouse, a touch panel, and a voice instruction device. The communication unit 13b is a circuit for accessing the communication network 301 and is operated according to a predetermined communication protocol.

The CPU 14b may be one or plural semiconductor chips or may be a computer device such as a calculator server. The CPU 14b executes a computer program read from the program database 24b to the memory 15b to perform calculating the system state, calculating the voltage phase target value, calculating the generator command value, instructing to-be-displayed image data, and searching data in various databases. The computer program may be stored in a computer-readable storage medium and may be installed from the computer-readable storage medium to the calculation server 210.

The memory 15b is, for example, a RAM and stores the computer program read from the program database 24b or temporarily stores image data for display, system state data, voltage phase target value data, generator command value data, and other calculation temporary data, and calculation result data.

The system state display screen which is generated by the display control unit 37 to be stored in the memory 15b is displayed by the display unit 11b. An example of the system state display screen will be described later.

Hereinafter, the databases in the calculation server 210 will be described.

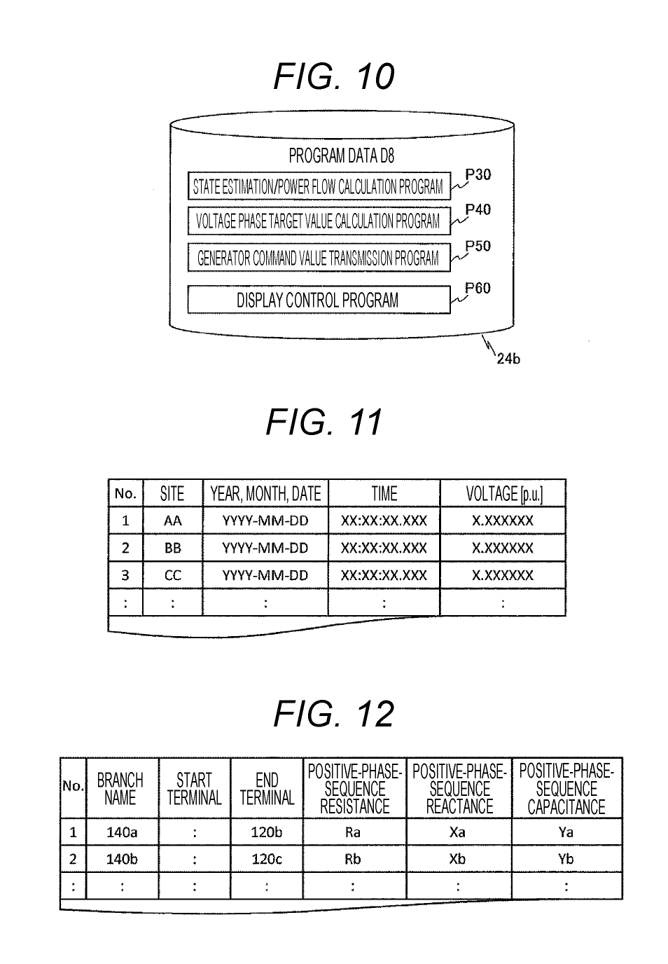

FIG. 10 illustrates stored contents of the program database 24b. Program data D8 are stored in the program database 24b. The program data D8 include, for example, a state estimation calculation/power flow calculation program P30, a voltage phase target value calculation program P40, a generator command value transmission program P50, and a display control program P60. The state estimation calculation/power flow calculation program P30 allows the CPU 14b function as the state estimation/power flow calculation unit 33. The voltage phase target value calculation program P40 allows the CPU 14b function as the voltage phase target value calculation unit 34. The generator command value transmission program P50 allows the CPU 14b function as the generator command value transmission unit 35. The display control program P60 allows the CPU 14b function as the display control unit 37.

The system data D5 are stored in the system database 25. The system data D5 include absolute time added power information measured by a sensor in the power system 100 and network configuration information representing a configuration of the power network of the power system 100. The sensor is, for example, the measurement device 40.

FIG. 11 illustrates the absolute time added power information. The absolute time added power information represents a measured value measured by the sensor installed in the power system 100. The absolute time added power information includes a measured value number, a site of sensor measuring the measured value, a date (year, month, date) of a time cross-section of the measured value, a time of the time cross-section, and a measured voltage for each measured value.

Besides, a voltage, a current, a power factor, and the like are measured by the sensor installed in the power system 100. The calculation server 210 receives the measured values and stores the measured values as the system data D5. Herein, the calculation server 210 may receive the measured values measured by the sensor through a system management server (not shown) such as a central power feed command station. In addition, in the case where the measured value measured by the sensor cannot be obtained, the calculation server 210 may store a planned value or a control command value as the system data D5 instead of the measured value.

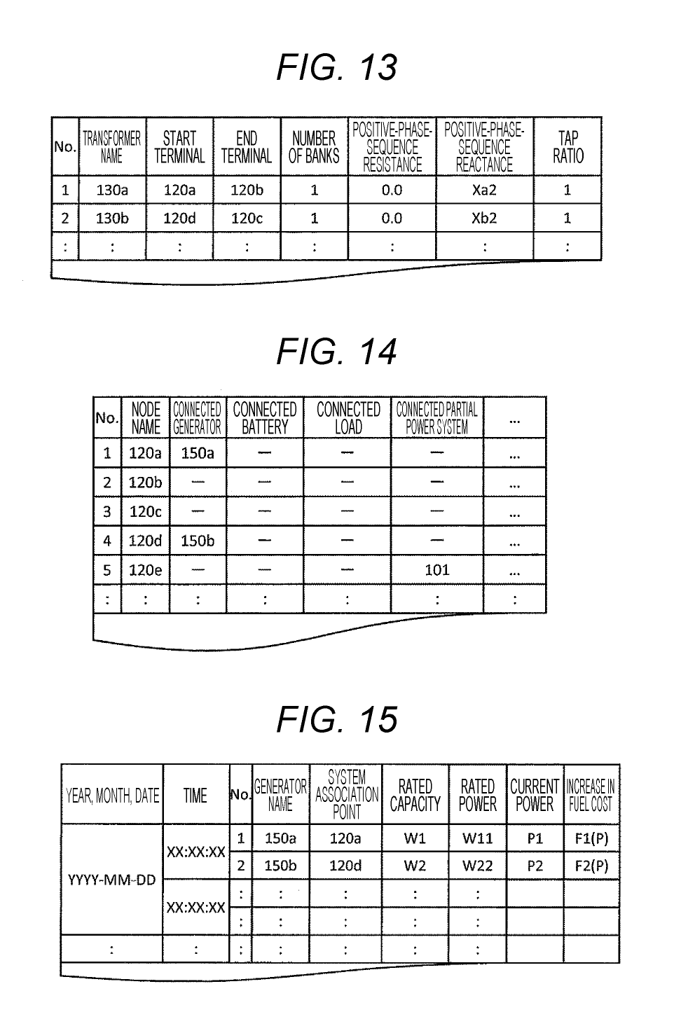

FIG. 12 illustrates branch information included in network configuration information. The branch information represents constants with respect to the branches. The branch information includes a branch number, a branch name, a start terminal, an end terminal, a positive-phase-sequence resistance, a positive-phase-sequence reactance, and a positive-phase-sequence capacitance for each branch. FIG. 13 illustrates transformer information included in the network configuration information. The transformer information represents constants with respect to the transformers. The transformer information includes a transformer number, a transformer name, a start terminal, an end terminal, the number of banks, a positive-phase-sequence resistance, a positive-phase-sequence reactance, a positive-phase-sequence capacitance, and a tap ratio for each transformer. The connection relationship among the branches 140a and 140b, the transformers 130a and 130b, and the nodes 120a, 120b, 120c, and 120d is represented by the network configuration. FIG. 14 illustrates node information included in the network configuration information. The node information represents constants with respect to the nodes. The node information includes a node number, a node name, a connected generator representing a generator connected to the node, a connected battery representing a battery connected to the node, a connected load representing a load connected to the node, and a connected partial power system representing a partial power system connected to the node. The connection relationship among the nodes 120a, 120b, 120c, 120d, and 120e, the generators 150a and 150b, the battery, the load, and the partial power system 101 is represented by the network configuration. In addition, the data of the network configuration may be input to the calculation server 210 by user's manipulation of the input unit 12a, or the calculation server 210 may receive the data of the network configuration from the management system or the like.

The generator data D6 are stored in the generator database 26. The generator data D6 represent data of each generator for each time cross-section. FIG. 15 illustrates the generator data D6. The generator data D6 include a date of a time cross-section, a time of the time cross-section, a data number, a generator name, a system association point which is a point where the generator is associated with the power system 100, a rated capacity of the generator, a rated power of the generator, a current power of the generator, and an increase in fuel cost of the generator. The generator data D6 may further include measured values of the sensor installed in the generator or planned values. In addition, in the case where there is a generator which can be controlled by the calculation server 210, the calculation server 210 calculates a control command value for the generator together with the specific time added voltage phase target data D1. In the case where there is no generator which can be controlled by the calculation server 210, the calculation server 210 does not calculate the control command value for the generator. In this case, the calculation server 210 may not include the generator data D6.

The system constraint data D7 are stored in the system constraint database 27.

The system constraint data D7 include voltage constraint data and power flow constraint data of the power system 100.

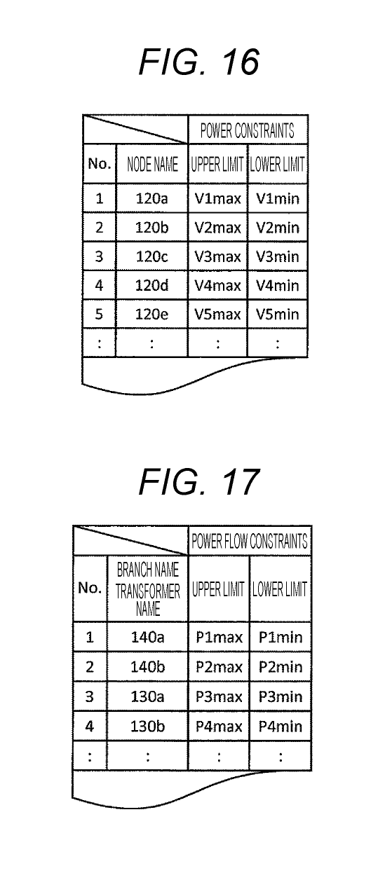

FIG. 16 illustrates the voltage constraint data. The voltage constraint data represent power constraints for each node in some time cross-section. The voltage constraint data include a node number, a node name, and upper and low limits of voltage at the node.

FIG. 17 represents the power flow constraint data. The power flow constraint data represent power flow constraints for each of system facilities such as a branch and a transformer in the power system 100 in some time cross-section. The power flow constraint data include a system facility number, a system facility name, and upper and lower limits of power flow at the system facility.

Pre-calculated values of the voltage constraint data and the power flow constraint data may be input to the calculation server 210, and the voltage constraint data and the power flow constraint data may be received from the above-described management system.

### --Calculation Process of Calculation Server 210--

Hereinafter, a calculation process of the calculation server 210 will be described. In the calculation process, the calculation server 210 estimates the system state of the power system 100 at a specific time in the future by using the system data D5 to store the estimated system state and determines whether or not the estimated system state satisfies a system state condition. The system state condition is determined based on the system constraint data D7. The system state condition is, for example, that the voltage stability constraint is satisfied. In this case, the voltage stability constraint is, for example, that the voltage stability margin is in a predetermined range. In addition, the system state condition may be that a transmission/distribution loss is minimized (loss minimization). In this case, the system state condition is, for example, that the transmission/distribution loss is in a predetermined range or that a change in transmission/distribution loss is a predetermined threshold value or less. In addition, the system state condition may also be that the voltage stability constraint is satisfied and the transmission/distribution loss is minimized. The system state condition may also be that an available transfer capability (ATC) is maximized.

The calculation server 210 estimates the system state of the power system 100. In the case where the system state does not satisfies the system state condition, the calculation server 210 calculates the specific time added voltage phase target data D1 and the control command value and transmits the specific time added voltage phase target data D1 for the system control device 10 and the control command for the generator 150. The calculation server 210 repeats this process until the system state satisfies the system state condition. In the case where the system state satisfies the system state condition, the calculation server 210 displays the system state on the display unit 11b and ends the calculation process.

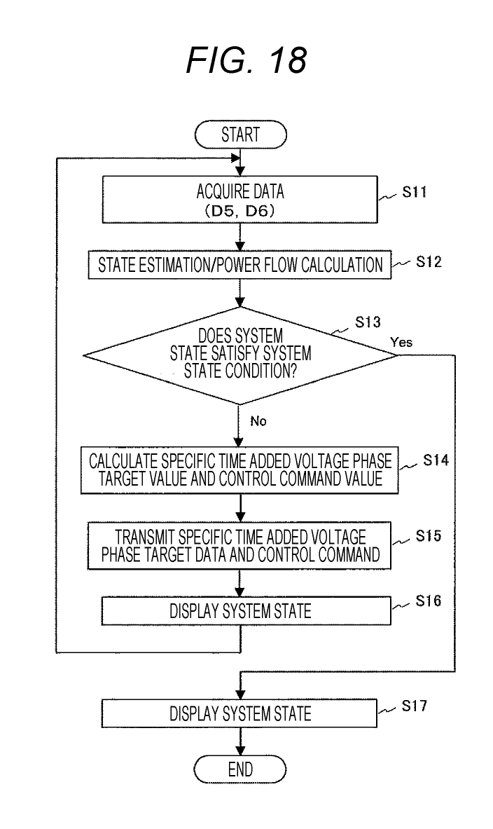

FIG. 18 illustrates the calculation process of the calculation server 210,

In step S11, the state estimation/power flow calculation unit 33 acquires data required for state estimation calculation/power flow calculation, control command value calculation, and generator command value calculation. Herein, the state estimation/power flow calculation unit 33 stores the system data D5 and the generator data D6 received from the measurement device in the power system 100 in the system database 25 and the generator database 26, respectively. Herein, the system data D5 and the generator data D6 may be input by user's manipulation of the input unit 12b, or the calculation server 210 may receive the system data D5 and the generator data D6 via the communication network 300. In addition, in the case where the system data D5 and the generator data D6 are input by the user, the CPU 14b is allowed to generate the required image data and display the image data on the display unit 11b. In the case, the CPU 14b may execute semi-manual input by using a complementary function so that a larger amount of data than the input amount can be set. In the case where the calculation server 210 receives the system data D5 and the generator data D6, the CPU 14b may indirectly receive the system data D5 and the generator data D6 through the system management server of an aggregator, a power company, or a broker which contracts with each home consumer and the management system such as CEMS or HEMS and may set the system data and the generator data in the system database 25 and the generator database 26, respectively.

In step S12, the state estimation/power flow calculation unit 33 performs the state estimation calculation and the power flow calculation by using the state estimation/power flow calculation program P30 and stores the calculation result in the memory 15b.

Herein, the state estimation/power flow calculation unit 33 performs the state estimation calculation of estimating the system state of the power system 100 at a specific time by using the system data D5. The system data D5 include observation data and connection data of a transformer substation, a power plant, and a transmission/distribution device having a transmission line as a starting end. The state estimation calculation determines based on the observation data and the connection data whether or not there exist abnormal data among the observation data, performs removing the abnormal data, and estimates an appropriate system state at the specific time. The observation data are the absolute time added power information or the value which can be acquired among the active power P, the reactive power Q, the voltage V, and the phase δ of the voltage. The connection data are the network configuration information. With respect to the state estimation calculation, for example, various methods disclosed in NIL 1 are employed.

Furthermore, the state estimation/power flow calculation unit 33 performs the power flow calculation by using the voltage V and phase δ of each node in the power system 100 and the active power P and reactive power Q which are the control command values of the load. Herein, for example, the state estimation/power flow calculation unit 33 designates the P and V to generator nodes, synchronous phase modifiers, and var compensators in the power system 100, designates the P and Q to transformer substation nodes and load nodes, and designates predetermined node voltage V and phase δ to predetermined slack nodes in the power system 100. Next, the state estimation/power flow calculation unit 33 performs the power flow calculation according to a Newton-Raphson method by using an admittance matrix Yij produced from the system data D5. Details of the power flow calculation will be described later. In addition, the power flow calculation is based on an AC method, but a DC method or a flow method may be employed. In addition, the state estimation/power flow calculation unit 33 performs the power flow calculation based on a current power flow state measured by each sensor in the power system 100. In this case, the state estimation/power flow calculation unit 33 obtains the P and the Q from the voltages V, the currents I, and the power factors cos φ measured by the sensors.

In step S13, the state estimation/power flow calculation unit 33 determines whether or not the estimated system state satisfies the system state condition. In the case where it is determined that the system state satisfies the system state condition (S13: Yes), state estimation/power flow calculation unit 33 transfers the process to step S17, and in the case where the system state does not satisfy the system state condition (S13: No), the state estimation/power flow calculation unit transfers the process to step S14.

Herein, the process of the case where it is determined as a result of step S13 that the system state does not satisfy the system state condition (S13: No) will be described.

In step S14, the voltage phase target value calculation unit 34 calculates the control command values of the generators 150a and 150b and the specific time added voltage phase target data D1 by using the estimated system state, the generator data D6, and the system constraint data D7 so that the power system 100 is in a desired system state. The desired system state is a system state where the voltage stability constraint is satisfied and which is optimized with respect to the specific parameters. The system state which is optimized with respect to the specific parameters is, for example, a system state where a total fuel cost is minimized or a system state where a transmission loss is minimized. Herein, for example, the voltage phase target value calculation unit 34 performs voltage stability constraint added optimal power flow (OPF) calculation. The voltage stability constraint added optimal power flow calculation is calculation of optimal power flow where constraints for the voltage stability are incorporated. Details of the voltage stability constraint added optimal power flow calculation will be described later.

In step S15, the generator command value transmission unit 35 transmits the calculated control command values for the generators 150a and 150b to the generators 150a and 150b, respectively. Furthermore, the voltage phase target value calculation unit 34 transmits the calculated specific time added voltage phase target data D1 to the system control device 10.

In step S16, the voltage phase target value calculation unit 34 receives, from the measurement device, how generator outputs, voltage phase, and the like of the generators 150a and 150b are changed with respect to the transmitted control command values and the transmitted specific time added voltage phase target data D1. Next, the voltage phase target value calculation unit 34 generates a system state display screen illustrating the system state which is based on a reception result and displays the system state display screen on the display unit 11b. The system state display screen will be described later. The voltage phase target value calculation unit 34 may calculate a control effect representing effects of the transmitted control command value and the transmitted specific time added voltage phase target data D1. The control effect represents, for example, an increase amount of the voltage stability margin. Next, the voltage phase target value calculation unit 34 transfers the process to step S11.

In the second step S14 of the loop of steps S11 to S16, the voltage phase target value calculation unit 34 gradually changes the control command value and the specific time added voltage phase target data D1 by feeding the control effect back so that the system state satisfies the system state condition. This loop is performed until the system state satisfies the system state condition in step S13. In addition, the voltage phase target value calculation unit 34 may perform time-series learning for each predetermined time zone in advance to produce a time-zone model representing the control effect of the reactive power or the voltage of the control target device and calculate the specific time added voltage phase target data D1 by using the time-zone model. In addition, in the case where the loop is performed a predetermined number of times so that an endless loop does not occur, the state estimation/power flow calculation unit 33 forcibly transfers the process to step S17.

Herein, the process of the case where it is determined as a result of step S13 that the system state satisfies the system state condition (S13: Yes) will be described.

In step S17, the voltage phase target value calculation unit 34 generates the above-described system state display screen, displays the system state display screen on the display unit 11b, and ends the flow.

Heretofore, the flow of the calculation process is described.

The calculation server 210 estimates the system state of the power system 100 and calculates the specific time added voltage phase target data D1 so that the system state satisfies the system state condition. Therefore, the power system 100 is allowed to in the desired system state.

### --Power Flow Calculation--

Hereinafter, an example of the power flow calculation in the above-described step S12 will be described.

Herein, a relationship between variables and unknowns of a power equation for applying the power flow calculation according to the Newton-Raphson method is represented. A power equation of an n-node system may be expressed by the following Mathematical Formula (1).

$$\begin{matrix}[ Mathematical Formula 1 ] & \\ {P}_{i} + {jQ}_{i} = {\sum }_{j = 1}^{n} {Y}_{ij} {V}_{i} {V}_{j} \{ cos ( {δ}_{ij} - {θ}_{ij} ) + j sin ( {δ}_{ij} - {θ}_{ij} ) \} & ( 1 )\end{matrix}$$

Therefore, Mathematical Formula (1) may be expressed as the following Mathematical Formula (2) or (3).

$$\begin{matrix}[ Mathematical Formula 2 ] & \\ {P}_{i} = {\sum }_{j = 1}^{n} {Y}_{ij} {V}_{i} {V}_{j} cos ( {δ}_{ij} - {θ}_{ij} ) \\ {Q}_{i} = {\sum }_{j = 1}^{n} {Y}_{ij} {V}_{i} {V}_{j} sin ( {δ}_{ij} - {θ}_{ij} ) & ( 2 ) \\ [ Mathematical Formula 3 ] & \\ {P}_{i} = {\sum }_{j = 1}^{n} {Y}_{ij} {V}_{i} {V}_{j} sin ( {δ}_{ij} + {α}_{ij} ) \\ {Q}_{i} = - {\sum }_{j = 1}^{n} {Y}_{ij} {V}_{i} {V}_{j} cos ( {δ}_{ij} + {α}_{ij} ) & ( 3 )\end{matrix}$$

Herein, αij is expressed by the following Mathematical Formula (4).

$$\begin{matrix}[ Mathematical Formula 4 ] & \\ {α}_{ij} = \frac{π}{2} - {θ}_{ij} & ( 4 )\end{matrix}$$

In this case, since there are 4n variables and 2n equations, if 2n variable values are fixed by using the Newton-Raphson method, the remaining 2n variable values are defined. Normally, each of the n nodes is classified as any one of swing nodes (slack nodes), P-Q designated nodes, and P-V designated nodes. With respect to the site where the phase δ of the voltage is measured, any one of δ, P, V, and Q may be considered to be a designated node. In addition, in the swing node, V and δ are known, and P and Q are unknown. In addition, one swing node is required to the system. In the P-Q designated node, P and Q are known, and V and δ are unknown. Normally, many modes are considered to be the P-Q designated nodes. In the P-V designated node, P and V are known, and Q and δ are unknown. In many cases, the generator node is considered to be the P-V designated node.

According to the power flow calculation, even in the case where the measured values of δ of the required sites in the power system 100 cannot be obtained, if any one of δ, P, V, and Q is measured by each of the electric devices, the remaining δ, P, V, and Q can be calculated from a combination of the measured values.

In the case where the measured values of δ, P, V, and Q, of which the number is larger than the required number can be obtained by the sensors in the power system 100, the state estimation/power flow calculation unit 33 may compare accuracies of the measured values and select the measured values, of which accuracies satisfy a predetermined condition based on the comparison result. The calculation server 210 calculates the specific time added voltage phase target data D1 by using the selected measured values, so that it is possible to improve the accuracy of the specific time added voltage phase target data D1.

### --Voltage Stability Constraint Added Optimal Power Flow Calculation--

Hereinafter, an example of the voltage stability constraint added optimal power flow calculation in the above-described step S14 will be described. The voltage stability constraint added optimal power flow calculation can be formulated as follows.

$$\begin{matrix}[ Mathematical Formula 5 ] & \\ {Minimize}_{x , y , u} f ( x , y , u ) & ( 5 ) \\ [ Mathematical Formula 6 ] & \\ Subject to {g}_{1} ( x , u ) = 0 & ( 6 ) \\ [ Mathematical Formula 7 ] & \\ {g}_{2} ( x , y , u ) = J ( x , u ) y - \frac{d p ( λ )}{d λ} = 0 & ( 7 ) \\ [ Mathematical Formula 8 ] & \\ {g}_{3} ( x , y , u ) \leq 0 & ( 8 )\end{matrix}$$

In Mathematical Formula (5), f(x, y, u) is an objective function which is to be optimized. The objective function is optimized with respect to specific parameters. Mathematical Formula (6) denotes a power flow equation. λ is an increase rate of total demand. Mathematical Formula (7) denotes an equality constraint which a total demand voltage sensitivity vector is to satisfy. Mathematical Formula (8) denotes upper and lower limit constraints for a magnitude of a voltage, branch power flow, or the like. By providing upper and lower limits to voltage sensitivities dVi/dλ included in y, the voltage sensitivities of all the load bus lines are considered.

However, in the target power system 100, it is considered that the total demand P is increased from the value P0 of the initial operating point to P=(1+λ) P0. In this case, the voltage sensitivity is a gradient of a PV curve which is plotted in load bus lines i in the power system 100 by setting the horizontal axis to an increase rate λ of the total demand and the vertical axis to a bus line voltage. Herein, shares of increase amounts of the total demand P among the load bus lines and generator bus lines are given a priori.

x is a voltage vector representing a magnitude and a phase angle of a bus line voltage. u is a control amount involved with an admittance matrix of the system such as a power capacitor input amount and a transformer tap ratio. p is an active power input to a bus line in a PV-designated bus line and is a designated value vector configured with an active power and a reactive power which are input to bus lines in the other bus lines. y is a sensitivity (total demand voltage sensitivity) of a change of a voltage solution x with respect to a change in λ. J(x, u) is a Jacobian matrix with respect to x of a power flow equation. dp(λ)/dλ is an increase scenario of each load with respect to an increase in total demand.

By solving the optimization problem of Mathematical Formulas (5) to (8), it is possible to allow the voltage sensitivity to have a margin in a predetermined range and to obtain a system state optimized with respect to specific parameters.

### --Control Effect--

Hereinafter, the control effects of the calculation process and the system control process will be described.

Herein, an increase amount of the voltage stability margin is used as the control effect. In addition, two control methods for increasing the voltage stability margin by the calculation process and the system control process are exemplified.

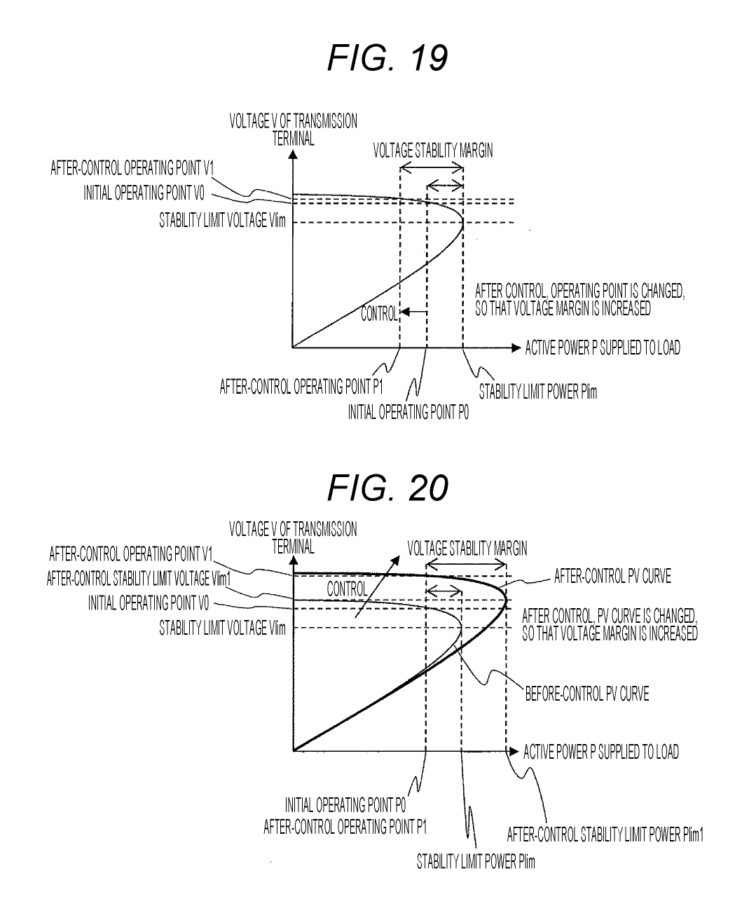

The first control method is control of changing an operating point. FIG. 19 illustrates a change in voltage stability margin by the control of changing the operating point. In this figure, the horizontal axis denotes an active power P supplied to the load, and the vertical axis denotes a voltage V of power transmission terminal V. In a PV curve illustrated in this figure, the stability limit power is denoted by Plim, and an initial operating point is denoted by P0. The operating point is controlled to be lower than the initial operating point P0, and after, the operating point is changed to an operating point P1, so that the after-control voltage stability margin (Plim-P1) is increased to be higher than the before-control voltage stability margin (Plim-P0).

The second control method is control of changing a PV curve. FIG. 20 illustrates a change in voltage stability margin by control of changing the PV curve. This figure illustrates a before-control PV curve and an after-control PV curve. In the before-control PV curve, the before-control stability limit power is denoted by Plim, and in the after-control PV curve, the after-control stability limit power is denoted by Plim1. The after-control operating point P1 is equal to the initial operating point P0. By changing the PV curve, the after-control stability limit power Plim1 is allowed to be higher than the before-control stability limit power Plim, so that the after-control voltage stability margin (Plim1-P1) is increased to be higher than the before-control voltage stability margin (Plim-P0). Therefore, without changing the operating point, it is possible to increase the voltage stability margin.

In addition, a combination of the first control method and the second control method may be used as a control method of increasing the voltage stability margin.

In addition, the voltage phase target value calculation unit 34 may calculate the voltage stability margin and transmit the calculated voltage stability margin to the system control device 10. In this case, the system control device 10 displays the voltage stability margin as the control effect. In addition, the voltage phase target value calculation unit 34 may display the calculated voltage stability margin on the display unit 11b.

The specific time added voltage phase target data D1 are calculated so that the calculation server 210 increases the voltage stability margin, and the system control device 10 controls the control target device based on the specific time added voltage phase target data D1, so that it is possible to implement the system state satisfying the voltage stability constraint.

### --Display Screen of System Control Device 10--

Hereinafter, the control result display screen displayed in the above-described steps S6 and S7 will be described.

The display control unit 38 receives the voltage stability margin from the calculation server 210. After that, the display control unit 38 generates the control result display screen based on the control command produced by the control command value calculation unit 32, the voltage phase difference calculated by the voltage phase difference calculation unit 31, and the received voltage stability margin and displays the control result display screen on the display unit 11a.

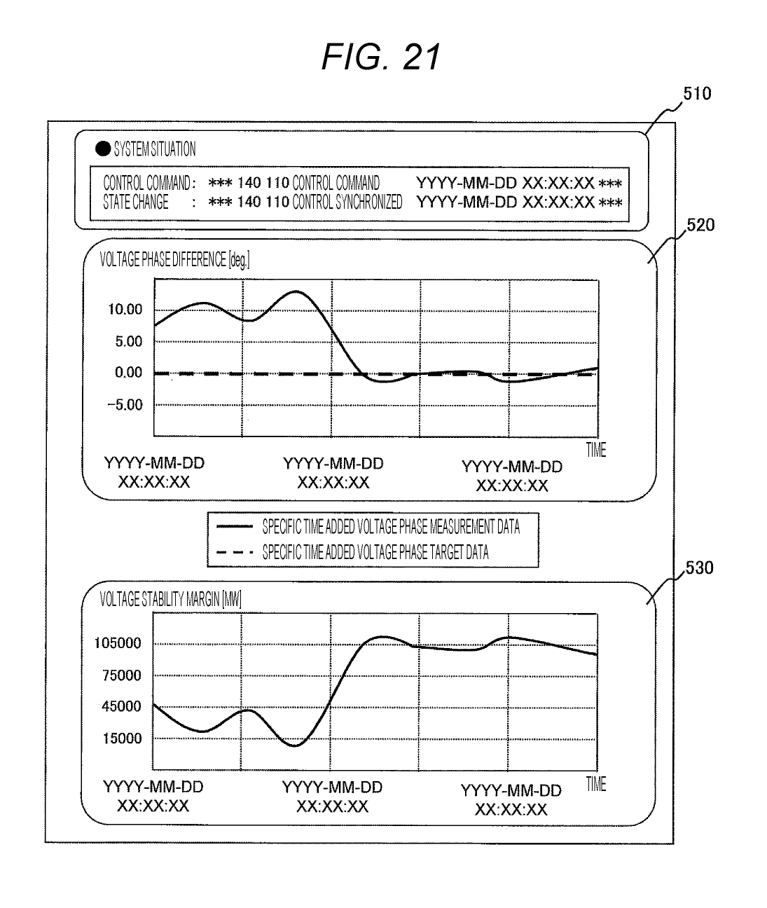

FIG. 21 illustrates the control result display screen. The control result display screen is configured to include a system situation display portion 510, a voltage phase difference display portion 520, and a voltage stability margin display portion 530. The system situation display portion 510 represents content and time of the control command transmitted to the control target device and content and time of the state change received from the control target device. The voltage phase difference display portion 520 represents a time change of the specific time added voltage phase target data D1 and a time change of the specific time added voltage phase measurement data D2. In the voltage phase difference display portion 520, the horizontal axis denotes a time, and the vertical axis denotes a voltage phase difference. The voltage stability margin display portion 530 represents a time change of the voltage stability margin of the power system 100. In the voltage stability margin display portion 530, the horizontal axis denotes a time of synchronization with the voltage phase difference display portion 520, and the vertical axis denotes the voltage stability margin.

According to the control result display screen, when the control command is made and how the voltage phase difference is changed are displayed in a time-series manner, so that the user can easily check the effects. In addition, how much the voltage phase difference is decreased by the control command and how much the voltage stability margin is increased are displayed in a time-series manner, so that there is an advantage in that it is easy to intuitively recognize the control effect. Herein, although an example of the screen output is disclosed, data having a format which is printable on a document may also be provided to the user.

The control result display screen may illustrate a change amount of the voltage phase difference or a change amount of the voltage stability margin. The control result display screen may display the above-described PV curve so as to illustrate the change in voltage stability margin. In addition, the calculation server 210 may calculate the transmission loss in the power system 100 and transmits the transmission loss to the system control device 10. In this case, the control result display screen may illustrate a time change in transmission loss. In addition, the calculation server 210 may calculate the available transfer capability of the entire power system 100 and transmit the available transfer capability to the system control device 10. In this case, the control result display screen may illustrate a time change in available transfer capability.

According to the control result display screen, a manager of the system control device 10 can check a result of the control of the control target device performed by the system control device 10.

### --System State Display Screen by Calculation Server 210--

Hereinafter, the system state display screen illustrated in the above-described steps S16 and S17 will be described. The display control unit 37 generates the system state display screen based on the system data D5 and the estimated system state and displays the system state display screen on the display unit 11b.

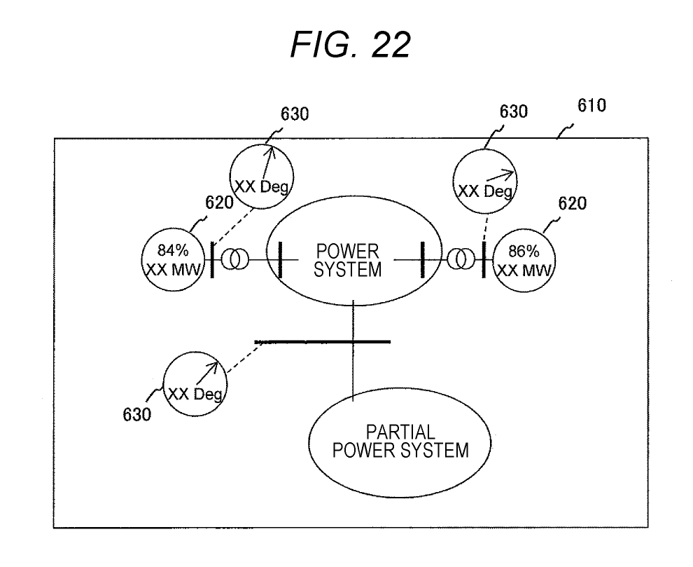

FIG. 22 illustrates the system state display screen. The control result display screen is configured to include a power system display portion 610, a generator state display portion 620, and a voltage phase display portion 630. The power system display portion 610 is a system diagram illustrating a configuration of the power system 100. The generator state display portion 620 is arranged to correspond to the generator in the power system display portion 610 and illustrates the generator state. The generator state is, for example, a current power of the generator and a ratio of the current power to the rated power of the generator based on the generator data D6. The generator state may be any one of the current power of the generator and the ratio of the current power to the rated power of the generator. The voltage phase display portion 630 is arranged to correspond to the measurement device 40 in the power system display portion 610 and the voltage phase measured by the measurement device 40. The voltage phase display portion 630 may illustrate the amplitude and phase of the voltage in the measurement device 40, may illustrate a waveform of the voltages in the measurement device 40, and may illustrate a phase difference of the measured voltage phase with respect to the specific time added voltage phase target data D1.

According to the system state display screen, a manager of the calculation server 210 can check a result of the control of the control target device performed by the system control device 10.

In addition, the calculation server 210 transmit the information required for the system state display screen to the system control device 10, so that the display control unit 38 of the system control device 10 may display the information such as the system state display screen on the display unit 11a. In addition, the display control unit of the calculation server 210 may display the information such as the control result display screen on the display unit 11b.

### Second Embodiment

In the embodiment, an example where the system control device 10 can acquire line parameters in the partial power system 101 and calculates the control command value for the control target device by using the line parameters will be described.

### --Control Command Value Calculation Method by System Control Device 10--

If the line parameters X, R, and P in the partial power system 101 are known, the control effect to δ at the time of controlling Q by using the following Mathematical Formula (9) can be calculated by using the following Mathematical Formula.

$$\begin{matrix}[ Mathematical Formula 9 ] & \\ δ = {sin}^{- 1} ( \frac{XP - RQ}{{V}_{s} {V}_{r}} ) & ( 9 )\end{matrix}$$

The control command value calculation unit 32 determines the control command value for the control target device based on the estimated value of the control effect. In addition, δ<<1 rad and Vs≈Vr≈1 pu, the control effect can be calculated by the following Mathematical Formula (10).

[Mathematical Formula 10]

δ≈XP−RQ (10)

In order to improve the accuracy of the control, the control command value calculation unit 32 may estimate a system model of the partial power system 101 based on the absolute time added power information received from the measurement device 40. The line parameters of some line can be estimated by installing the measurement devices 40 measuring the absolute time added power information at the two ends of the line. Therefore, even in the case where the system model cannot be acquired in advance, the system model can be estimated.

According to the embodiment, more accurate control command values than those of the first embodiment can be calculated, so that it is possible to reduce the number of control times by using the control command. Therefore, it is possible to reduce a deterioration of the control target device. In addition, it is possible to reduce the possibility that the system control device 10 controls the control target device in the direction of a deterioration in system state.

### First Modified Example

Hereinafter, an example of the process of the system control device 10 of the case where the system control device 10 cannot receive the specific time added voltage phase target data D1 from the calculation server 210 will be described.

The calculation server 210 calculates emergency target data which are the specific time added voltage phase target data in an emergency in advance and transmits the emergency target data to the system control device 10. The control command value calculation unit 32 receives the emergency target data and stores the emergency target data in the specific time added voltage phase target database 21.

In the later-described expressions, substitute target information corresponds to, for example, the emergency target data.

In the case where the system control device 10 cannot receive the specific time added voltage phase target data D1 from the calculation server 210 due to communication failure, device trouble, or the like, in the above-described step S2, the voltage phase difference calculation unit 31 reads the emergency target data instead of the specific time added voltage phase target data D1. After that, the voltage phase difference calculation unit 31 calculates the voltage phase difference by subtracting the emergency target data from the specific time added voltage phase measurement data D2.

According to this process, even in the case where the system control device 10 cannot receive the specific time added voltage phase target data D1 from the calculation server 210 due to communication failure, device trouble, or the like, it is possible to control the control target device based on the emergency target data.

### Second Modified Example

Hereinafter, an example of the process of the system control device 10 in the case where the partial power system 101 is separated from the power system 100 will be described.

In the case where the voltage phase difference calculation unit 31 detects based on a notice or the like transmitted from the calculation server 210 that the partial power system 101 is separated from the power system 100, the voltage phase difference calculation unit 31 stores the measured value of the power phase before the system separation among the specific time added voltage phase measurement data D2 as before-separation voltage phase data in the specific time added voltage phase target database 21. In addition, the target value of the power phase before the system separation among the specific time added voltage phase target data D1 may be used as the before-separation voltage phase data.

Next, in the case where the voltage phase difference calculation unit 31 detects based on the notice or the like transmitted from the calculation server 210 that the partial power system 101 is associated with the power system 100 again, in the above-described step S2, the voltage phase difference calculation unit 31 reads the before-separation voltage phase data instead of the specific time added voltage phase target data D1. After that, the voltage phase difference calculation unit 31 calculates the voltage phase difference by subtracting the before-separation voltage phase data from the specific time added voltage phase measurement data D2.

According to this process, in the case where the partial power system 101 is associated with the power system 100 again, the power system can becomes close to a before-separation system state, so that it is possible to alleviate a shock during system associating period.

The disclosure described in the embodiment heretofore can be expressed as follows.

(Expression 1)

A system control device including: a storage unit which stores target information representing a target voltage phase of a specific site in a power system and measurement information representing a voltage phase of a measurement result of the specific site; and a control unit which controls a target device associated with the power system based on a difference between the measurement information and the target information.

(Expression 2)

The system control device according to Expression 1, wherein the control unit calculates a phase difference between the voltage phase represented in the target information and the voltage phase represented in the measurement information and decreases the phase difference by controlling the target device.

(Expression 3)

The system control device according to Expression 2, wherein the target information represents a target voltage phase of the specific site at a specific time, and the measurement information represents a voltage phase of a measurement result of the specific site at the specific time.

(Expression 4)

The system control device according to Expression 3, wherein the target device is associated with a system which is associated with the power system.

(Expression 5)

The system control device according to Expression 4, wherein the target information is estimated so that the power system state at the specific time satisfies a predetermined condition.

(Expression 6)

The system control device according to Expression 5, wherein the condition is that the power system state at the specific time satisfies a predetermined voltage stability constraint.

(Expression 7)

The system control device according to Expression 5, wherein the condition is that a transmission loss of the power system at the specific time is minimized.

(Expression 8)

The system control device according to Expression 5, wherein a plurality of pieces of power information are measured by a plurality of electric devices, each piece of power information includes any of an active power, a reactive power, a voltage, and a voltage phase, and the power system state at the specific time is estimated based on the pieces of power information.

(Expression 9)

The system control device according to Expression 5, wherein the target information is calculated by a calculator connected to the system control device and is transmitted to the system control device, and the control unit receives the transmitted target information and stores the target information in the storage unit, and the measurement information is measured by a measurement device which is installed at the specific site and connected to the system control device and is transmitted to the system control device, and the control unit receives the transmitted measurement information.

(Expression 10)

The system control device according to Expression 9, wherein the control unit receives a plurality of pieces of target information representing target voltage phases of the specific site at a plurality of specific times included in a specific time zone from the calculator, and the control unit receives a plurality of pieces of measurement information representing voltage phases of a measurement result of the specific site at the plurality of specific times from the measurement device.

(Expression 11)

The system control device according to Expression 9, wherein the storage unit stores substitute target information which is a substitute for the target information, and in the case where the control unit cannot receive the target information from the calculator, the control unit controls the target device in the power system based on a difference between the measurement information and the substitute target information.

(Expression 12)

The system control device according to Expression 4, wherein in the case where the system is separated from the power system, the control unit stores before-separation information representing the voltage phase of the specific site before the separation in the storage unit, and in the case where the system after the separation is associated with the power system, the control unit controls the target device based on a difference between the measurement information and the before-separation information.

(Expression 13)

The system control device according to Expression 2, wherein the control unit calculates a control command value of the target device so as to decrease the phase difference and transmits the control command including the control command value to the target device, and the control command value includes any of a reactive power or a voltage of the target device.

(Expression 14)

The system control device according to any one of Expressions 1 to 13, wherein each of the target information and the measurement information includes any of a phase of the voltage of the specific site and a complex number representing the voltage of the specific site.

(Expression 15)

A system control method including: in a system control device, storing target information representing a target voltage phase of a specific site in a power system and measurement information representing a measurement result for a voltage phase of the specific site; and in the system control device, controlling a target device associated with the power system based on a difference between the measurement information and the target information.

### REFERENCE SIGNS LIST

10 system control device
21 specific time added voltage phase target database
22 specific time added voltage phase measurement database
23 control device database
24 program database
25 system database
26 generator database
27 system constraint database
31 voltage phase difference calculation unit
32 control command value calculation unit
33 state estimation/power flow calculation unit
34 voltage phase target value calculation unit
35 generator command value transmission unit
35 target power amount calculation unit
37 display control unit
38 display control unit
40 measurement device
100 power system
101 partial power system
210 calculation server

1. A system control device comprising:
a storage unit which stores target information representing a target voltage phase of a specific site in a power system and measurement information representing a voltage phase of a measurement result of the specific site; and
a control unit which controls a target device associated with the power system based on a difference between the measurement information and the target information.

2. The system control device according to claim 1, wherein the control unit calculates a phase difference between the voltage phase represented in the target information and the voltage phase represented in the measurement information and decreases the phase difference by controlling the target device.

3. The system control device according to claim 2, wherein the target information represents a target voltage phase of the specific site at a specific time, and the measurement information represents a voltage phase of a measurement result of the specific site at the specific time.

4. The system control device according to claim 3, wherein the target device is associated with a system which is associated with the power system.

5. The system control device according to claim 4, wherein the target information is estimated so that the power system state at the specific time satisfies a predetermined condition.

6. The system control device according to claim 5, wherein the condition is that the power system state at the specific time satisfies a predetermined voltage stability constraint.

7. The system control device according to claim 5, wherein the condition is that a transmission loss of the power system at the specific time is minimized.

8. The system control device according to claim 5, wherein a plurality of pieces of power information are measured by a plurality of electric devices, each piece of power information includes any of an active power, a reactive power, a voltage, and a voltage phase, and the power system state at the specific time is estimated based on the pieces of power information.

9. The system control device according to claim 5,
wherein the target information is calculated by a calculator connected to the system control device and is transmitted to the system control device, and the control unit receives the transmitted target information and stores the target information in the storage unit, and
the measurement information is measured by a measurement device which is installed at the specific site and connected to the system control device and is transmitted to the system control device, and the control unit receives the transmitted measurement information.

10. The system control device according to claim 9, wherein the control unit receives a plurality of pieces of target information representing target voltage phases of the specific site at a plurality of specific times included in a specific time zone from the calculator, and the control unit receives a plurality of pieces of measurement information representing voltage phases of a measurement result of the specific site at the plurality of specific times from the measurement device.

11. The system control device according to claim 9, wherein the storage unit stores substitute target information which is a substitute for the target information, and in the case where the control unit cannot receive the target information from the calculator, the control unit controls the target device in the power system based on a difference between the measurement information and the substitute target information.

12. The system control device according to claim 4,
wherein in the case where the system is separated from the power system, the control unit stores before-separation information representing the voltage phase of the specific site before the separation in the storage unit, and
in the case where the system after the separation is associated with the power system, the control unit controls the target device based on a difference between the measurement information and the before-separation information.

13. The system control device according to claim 2, wherein the control unit calculates a control command value of the target device so as to decrease the phase difference and transmits the control command including the control command value to the target device, and the control command value includes any of a reactive power or a voltage of the target device.

14. The system control device according to claim 1, wherein each of the target information and the measurement information includes any of a phase of the voltage of the specific site and a complex number representing the voltage of the specific site.

15. A system control method comprising:
in a system control device, storing target information representing a target voltage phase of a specific site in a power system and measurement information representing a measurement result for a voltage phase of the specific site; and
in the system control device, controlling a target device associated with the power system based on a difference between the measurement information and the target information.
